(19) United States
(12) Patent Application Publication
(10) Pub. No.: US 2025/0065919 A1
(43) Pub. Date: Feb. 27, 2025

(54) AUTOMATED DRIVING SYSTEMS FOR SUPPORTING DRIVING MODE TRANSITION

(71) Applicant: KOREA AUTOMOTIVE TECHNOLOGY INSTITUTE, Cheonan-si, Chungcheongnam-do (KR)

(72) Inventors: Si Bok Yu, Cheonan-si, Chungcheongnam-do (KR); Jeong Tae Park, Cheonan-si, Chungcheongnam-do (KR); Yong Ki Lee, Cheonan-si, Chungcheongnam-do (KR); Yu Yeong Shin, Cheonan-si, Chungcheongnam-do (KR); Moon Hyung Song, Cheonan-si, Chungcheongnam-do (KR)

(73) Assignee: KOREA AUTOMOTIVE TECHNOLOGY INSTITUTE, Cheonan-si, Chungcheongnam-do (KR)

(21) Appl. No.: 18/719,584

(22) PCT Filed: Dec. 9, 2022
(86) PCT No.: PCT/KR2022/020002

§ 371 Date: Jun. 13, 2024

(30) Foreign Application Priority Data
Dec. 16, 2021 (KR) 10-2021-018450

(51) Int. Cl. B60W 60/00; G07C 5/00

(52) U.S. Cl. CPC B60W 60/00186; B60W 60/0053; G07C 5/008; B60W 2556/45

(57) ABSTRACT

The present invention relates to an automated driving system for switching between automated driving mode and manual driving mode in an automated driving situation, and a fallback method for an automated driving failure situation in the automated driving system. According to the present invention, the method comprises the steps of predicting whether, on a route a vehicle is traveling, the vehicle will deviate from an operational design domain (ODD) in which automated driving is possible; and when deviation is predicted, performing a minimal risk maneuver (MRM) process for controlling the vehicle to respond to an automated driving failure situation at a deviation point. According to the present invention, the stability of the automated driving system in emergency situations may be increased, and by proposing a stable mode-switching method for the automated driving system, the best response method may be provided.

### TECHNICAL FIELD

The present invention relates to an automated driving system for supporting driving mode transition between an automated driving mode and a manual driving mode during automated driving state.

### BACKGROUND ART

Typically, an automated driving system refers to technology that selects an optimal driving route and enables automated driving using techniques such as lane departure prevention control, lane change control, and obstacle avoidance control. This technology: relates to vehicle driving and allows a vehicle to reach its destination on its own without requiring the driver to operate the steering wheel, accelerator pedal, or brake.

A vehicle that drives itself without requiring the driver to operate it is a technology highlighted in the next-generation vehicle industry. In line with current trends, many automotive companies are developing technology for automated vehicles.

Several core technologies are required to realize automated driving. For example, these include a Highway Driving Assist (HDA) system that automatically maintains distance between vehicles on a highway, a Lane Keeping Assist System (LKAS), a Rear Blind Spot Detection (BSD) system, Cruise Control (or Advanced Smart Cruise Control), and an Automated Emergency Braking (AEB) system.

According to the Society of Automotive Engineers (SAE), automated vehicles are classified into levels 0 to 5, ranging from driver assistance systems (or Advanced Driver Assistance Systems (ADAS)) to fully automated vehicles (or Automated Driving Systems (ADS)). Vehicles that require no driver assistance are classified as level 3 or higher. In a level 3 system, an emergency fallback user (or fallback ready user (FRU)) must provide a fallback in emergency situations. In a level 4 or higher system, the automated vehicle must be capable of handling emergency situations, such as failures, on its own. Here, the fallback of an automated vehicle refers to control (or Minimal Risk Maneuver (MRM)) to automatically transition to a Minimal Risk Condition (MRC) in case of failure.

Therefore, a more detailed operational definition may be required to ensure stability based on the situation of the automated vehicle.

### DISCLOSURE

### Technical Problem

An object of the present invention is to propose a method for switching between automated driving mode and manual driving mode in an automated driving situation.

An object of the present invention is to propose a specific method for providing a fallback for a failure situation among various situations in automated driving.

### Technical Solution

According to an embodiment, a method is provided for offering a fallback in a failure situation occurring during automated driving performed by an automated driving system. The method includes predicting whether a vehicle will deviate from its Operational Design Domain (ODD) while driving autonomously along a route, and performing a Minimal Risk Maneuver (MRM) process to control the vehicle and provide a fallback for the failure situation based on the predicted deviation point.

The MRM process may include requesting the vehicle driver to intervene in the automated driving either at the predicted time of deviation or in advance, and switching to manual driving mode when control is handed over to the driver through intervention (or override).

The MRM process may include instructing an emergency stop of the vehicle when driver intervention is not possible.

The MRM process may involve necessary control operations based on the MRM type, which determines the stop type according to the diagnosis result of the vehicle's failure cause.

The MRM process may request safe zone information based on the MRM type and generate a route for the vehicle to stop in the designated safe zone.

The method may further include receiving a remote request from a control server to perform the MRM process when a deviation from the ODD or a failure situation is detected during driving. The control server provides the safe zone information when making the request to perform the MRM process.

### Advantageous Effect

According to the present invention, it is possible to increase the stability of the automated driving system in emergency situations.

Additionally, the present invention may provide the best fallback method by proposing a stable mode-switching method for the automated driving system.

Furthermore, the present invention may enable safer fallback by implementing a request for driver intervention in the MRM operation or conducting a safe zone search in advance.

### DESCRIPTION OF DRAWINGS

FIG. 1 is an example diagram showing an automated driving system according to an embodiment of the present invention.

FIGS. 2 and 3 are exemplary diagrams each showing a minimal risk maneuver (MRM) operation of the automated driving system according to an embodiment of the present invention.

FIGS. 4 to 9 are timing diagrams showing the process of the automated driving system according to an embodiment of the present invention.

### BEST MODE

The following description exemplifies only the principles of the present invention. Therefore, those skilled in the art may implement the principles of the present invention and develop various devices within the spirit and scope of the present invention, even if not explicitly described or shown in the specification. Additionally, it is understood that all conditional terms and embodiments mentioned in the specification are intended solely to help those skilled in the art understand the concept of the present invention, and the present invention is not limited to the specific embodiments and descriptions provided.

The above-mentioned objects, features, and advantages will become more apparent from the following detailed description in conjunction with the accompanying drawings. Consequently, those skilled in the art can easily practice the spirit of the present invention.

Furthermore, in describing the present invention, detailed descriptions of well-known technologies related to the present invention are omitted where they may unnecessarily obscure the gist of the present invention. Hereinafter, an embodiment of the present invention will be described in detail with reference to the accompanying drawings.

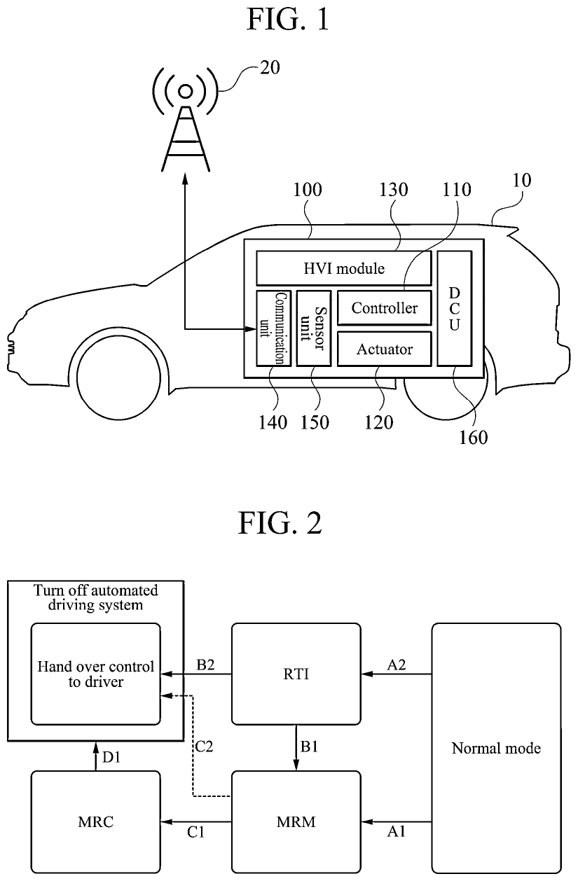

FIG. 1 is a diagram showing the configuration of an automated driving system (ADS) 100 in a vehicle 10 according to an embodiment of the present invention.

Referring to FIG. 1, an automated driving system 100 according to this embodiment may include a Human Vehicle Interface (HVI) module 130 for the interface between the user and the vehicle 10, a communication unit 140, a sensor unit 150, an automated driving controller 110, a Domain Control Unit (DCU) 160, and an actuator 120.

The HVI module 130 may be configured to interface between the automated vehicle 10 and the user, ensuring the convenience and safety of the driver by including a driver monitoring system (or Driver Status Monitoring (DSM) system) that assesses the driver's condition, a Human Vehicle Interface (HVI) that actively recognizes the driving mode of the vehicle 10 and provides an optimized interface, and a display that visually represents this information.

Specifically, the HVI module 130 may detect the driver's status through a vision sensor or various other sensors while simultaneously detecting and analyzing the driving mode or external driving environment of the vehicle 10. It can assess operational loads or abnormal situations and inform the driver through various interfaces. Additionally, the driver can recognize the control status of the vehicle 10, check its driving mode, and decide whether to intervene directly. The HVI module 130 can also indicate whether the current driving mode is automated or manual and display any changes in the driving mode.

The communication unit 140 is a device for transmitting and receiving data from external sources using various information and communication technologies, such as a telematics system. It may use cellular communications (e.g., 4th generation (4G) and Long-Term Evolution (LTE)), Wireless Access in Vehicular Environment (WAVE), or similar technologies. This communication technology enables communication between the vehicle 10 and other vehicles (vehicle-to-vehicle) or between the vehicle 10 and roadside units (RSU) (vehicle-to-infrastructure (V2I)).

The sensor unit 150 detects the mode and external environment of the vehicle 10 and acquires surrounding information for automated driving. It may include a camera, radar unit, infrared (IR) sensor, light detection and ranging (LIDAR) sensor, acoustic sensor, or similar devices.

Various sensor modules within the sensor unit 150 may be mounted directly on the vehicle 10 for automated driving and positioned optimally to gather information within a determined sensing range, considering the size and structure of the vehicle 10.

Additionally, the sensor unit 150 may include sensors for measuring the vehicle's 10 position or behavior, such as a gyroscope and an acceleration sensor, enabling it to internally determine the current driving mode of the vehicle 10.

The automated driving controller 110 generates and outputs control instructions for operating the automated vehicle 10. It is classified into various modules based on the processor's function to control behavior during automated driving.

For example, the automated driving controller 110 may include an Adaptive Cruise Control (ACC) module that performs adaptive cruise control through deceleration or acceleration, along with a controller for basic steering, acceleration, or deceleration. It may also include modules for lane maintenance and changes (such as lane centering, in-lane driving, lane change, or lane-keeping), left or right turns, vehicle stops, and controlling driving operations based on urban environments such as intersections or stops. Additionally, the automated driving controller 110 may include a minimal risk maneuver (MRM) module for executing MRM and a module for performing normal or emergency stops based on the MRM.

However, these internal components of the automated driving controller 110 may be integrated and operated as a single system. Consequently, the entire automated driving system 100 may become inoperative due to a failure in a communication line related to the sensor or a power supply issue.

Therefore, in this embodiment, the automated driving system 100 may classify and independently manage the automated driving controller 110.

For example, the automated driving controller 110 may be classified into a first controller and a second controller. The first controller may serve as a basic controller and include modules for low-level driving control, while the second controller may include modules for higher-level practical automated driving control.

The first and second controllers may be classified physically or by separating their power supplies and network connections in a software manner. Additionally, some components of the first controller or the second controller may be designed to overlap and be included in both controllers.

By separating the power supplies and networks of the first and second controllers and overlapping the design of their essential components, it is possible to minimize risk situations during automated driving and effectively perform essential MRM operations.

The actuator 120 may be a mechanical device responsible for the actual driving of the vehicle 10, implemented as an actuator for steering, acceleration, or deceleration.

The domain control unit (DCU) 160 may be configured to control the sensors, actuators, and other components required for driving the vehicle. The DCU 160 may be a more unified control device than conventional electronic control units (ECUs) distributed among various vehicle components, such as the powertrain, advanced driver assistance systems (ADAS) module, and vehicle body. The DCU 160 may integrate and control the modules necessary for automated driving.

Additionally, an automated driving recording module (not shown) may include an automated driving recording device (ADR) and an edge data logging device (or edge logger) to store information such as driving records and control data based on sensor information.

A map module may include a global navigation satellite system (GNSS) antenna, a map and positioning module, and a navigation display. This module can set a destination, generate a route, and provide navigation information based on the vehicle's current location.

The automated driving system 100 according to this embodiment described hereinabove is to provide a safe fallback by using an independent structure in a case where an emergency situation occurs in the automated driving due to a failure in the system or the problem in the power or the communication network.

Therefore, in first describing a process of providing the fallback for this situation with reference to FIG. 2, when detecting the abnormal situation described above in the automated driving during a normal driving mode, the automated driving system 100 may first trigger an MRM operation mode (21), and perform control operations defined in the MRM until the control operations reaches a minimal risk condition (MRC).

The automated driving system 100 may directly perform a change in the driving mode, and generate a request to intervene (RTI) in the automated driving by the driver before triggering the MRM to stop the vehicle (22).

In the request to intervene step, the automated driving system 100 may request the user (or fallback ready user) who is ready to perform the fallback for a failure situation to take over a driving control (24). However, in a case of level 4 or higher of the automated driving, the driver may not exist, and this step may be performed selectively.

In addition, when a timeout occurs even though the take-over of the control is requested, the automated driving system 100 may change the mode to the MRM mode (23), and perform the defined MRM operation.

Here, the MRM may include a series of operations of controlling the automated driving system 100 until the vehicle 10 reaches the MRC, and in a MRM situation, the automated driving system 100 may perform operations of determining a MRM type, informing the driver that the MRM operation is performed, or the like. Even in the MRM mode, the control may be given over to the driver based on whether the driver intervenes (26).

In a mode where a risk is minimized through the MRM, for example, when the vehicle stops in a safe zone, and the vehicle thus reaches the MRC (25), the automated driving system 100 may hand over the control to the driver (27), thereby allowing the driver to resume or return to the automated driving when the failure situation is resolved.

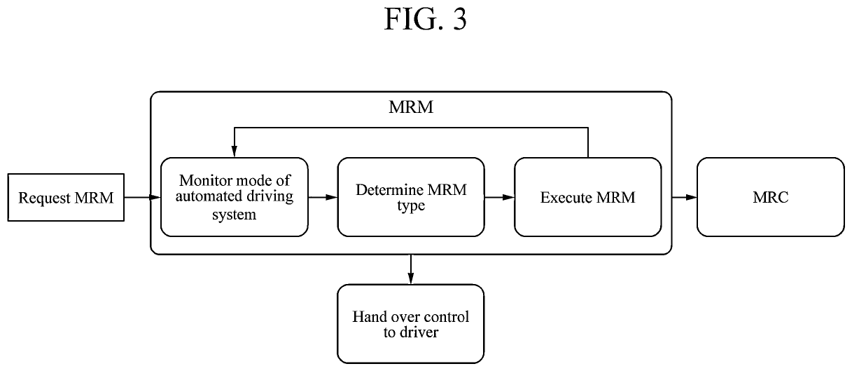

In detail, describing the operation based on the MRM and the MRC with reference to FIG. 3, when a problem occurs with the normal performance of the automated driving, the automated driving system 100 may first request the MRM operation if there is no control given to the driver (21).

Upon receiving the request for the MRM, the MRM module in the automated driving system 100 may monitor the system's mode (32) and determine the MRM type by identifying the vehicle's internal environment and external factors, such as a safe zone situation, based on the failure state or severity of the failure (33). The MRM module may classify the MRM type based on the stop situation into straight stop, in-lane stop, and adjacent lane stop.

A straight stop may indicate, for example, that in the most urgent situation, braking is performed in the direction the vehicle 10 is currently driving to bring the vehicle 10 to a stop. Therefore, the automated driving system 100 may not require lateral control, acceleration control, or lane change control, but will perform deceleration control for braking.

An in-lane stop may indicate that braking is performed to maintain the lane where the vehicle 10 is currently driving, bringing the vehicle 10 to a stop. Therefore, the automated driving system 100 may not require acceleration or lane change control, but will perform lateral control to maintain the lane and deceleration control for braking.

An adjacent lane stop may indicate that the vehicle 10 leaves the current lane and moves to another safer lane, where braking is then performed to bring the vehicle 10 to a stop. In this case, the automated driving system 100 may perform acceleration control to leave the current lane, lane change control to move to another lane, lateral control for lane movement or maintenance, and deceleration control for braking.

The automated driving system 100 may perform another stop type when a safe zone, searched through an external server or a roadside unit (RSU), is available. This may include, for example, a shoulder stop or a parking lane stop, allowing the vehicle to stop on a shoulder or in a parking/stopping zone.

The shoulder stop may be classified into a full-shoulder stop if the shoulder has a sufficient width (e.g., 2 m), and a half-shoulder stop in other cases.

Additionally, the determined MRM type may be flexibly changed based on changes in the internal or external environment, and the automated driving system 100 may execute the MRM operation based on the determined type (34). When the vehicle 10 stops based on the finally determined type, it may reach a mode where the risk is minimized to the MRC.

As described above, the automated driving system 100 may also request the fallback ready user to intervene during the MRM operation and directly hand over control to the fallback ready user (26).

In other words, the automated driving system 100 may detect situations where normal automated driving is impossible or restricted and control the driving based on the type determined by the MRM module for fallback. However, the failure situation that triggers the MRM may result from an interrelationship of the components in the automated driving system 100 or issues with external power or the network. The components in the automated driving system 100 may need to be classified and configured independently of each other to provide a more efficient fallback using operable devices.

Therefore, it is necessary to determine the MRM type and perform the MRM operation using the devices that remain operable even if some sensors or the power supply fail.

The automated driving system 100 in this embodiment may effectively separate or overlap internal components as needed to achieve this purpose.

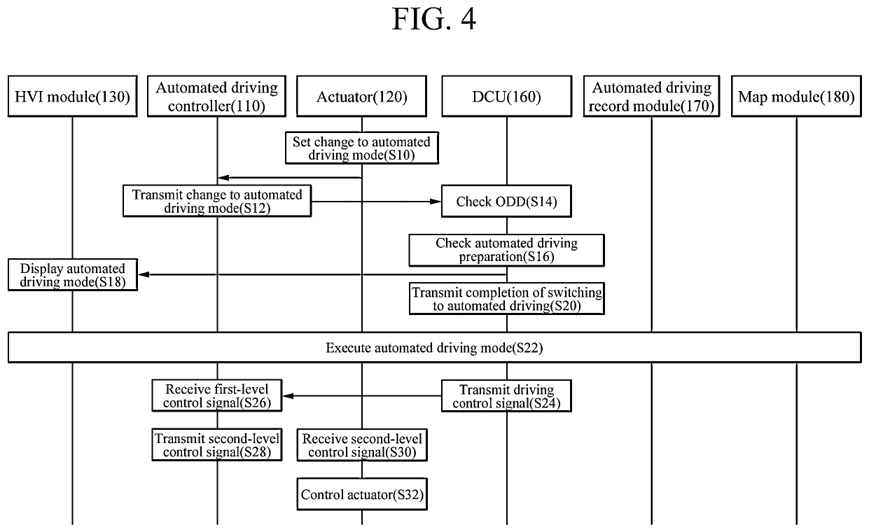

Hereinafter, the description outlines the operation of the automated vehicle 10 to perform the above-described MRM with reference to FIGS. 4 to 9.

FIG. 4 is a diagram showing the basic process of switching from manual driving mode to automated driving mode when no destination is set.

The process in FIG. 4 may operate in a mode where the driver commands switching from manual driving mode to automated driving mode. Each module then switches to automated driving mode or a mode where each module executes automatic longitudinal or lateral control, such as lane maintenance, vehicle speed maintenance, or vehicle distance maintenance, without navigation control to a destination because no destination is set by the driver.

When the change to automated driving mode is set (S10), a corresponding change request signal may be transmitted to the automated driving controller 110.

The automated driving controller 110 may transmit the change to automated driving mode to the DCU 160 based on the corresponding request signal (S12). The DCU 160 may determine whether the corresponding zone is within an operational design domain (ODD), i.e., a zone designed for automated driving, based on the current location of the automated vehicle 10 (S14).

Additionally, the DCU 160 may check the modes of the sensor and other automated driving modules to verify their readiness for automated driving. Here, the DCU 160 may also check if fallback for a failure state of automated driving is possible (S16).

If no abnormalities are found, the DCU 160 may display the automated driving mode using the HVI module 130 for the user to recognize the corresponding mode (S18).

Next, the DCU 160 may transmit the completion of the switch to automated driving mode to each device in the vehicle 10 for the automated driving mode to be executed (S20, S22).

In detail, after the mode is switched to automated driving mode, the DCU 160 may transmit a driving control signal to the automated driving controller 110 (S24).

The automated driving controller 110 may receive a first-level control signal among the driving control signals (S26). This first-level signal may be a relatively high level of control, including signals for controlling the second controller described above for automated driving.

Additionally, a relatively low second-level control signal among the driving control signals may be transmitted to the actuator 120 (S28), and the actuator may perform actuator control for steering and acceleration or deceleration based on the received second-level signal (S32).

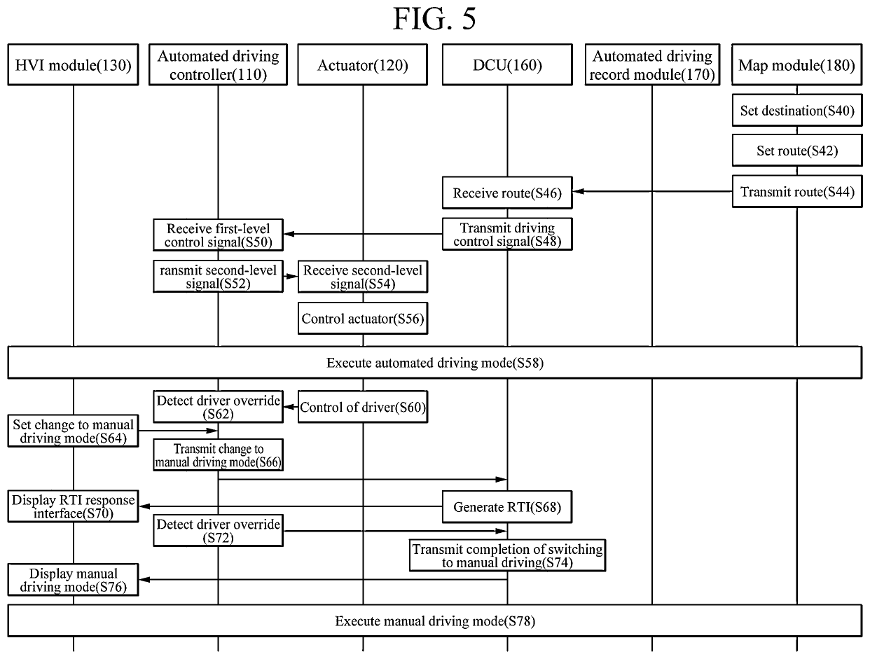

Hereinafter, the description outlines the operation of the automated vehicle 10 when the destination is set and the automated driving mode is terminated in this situation with reference to FIG. 5.

Referring to FIG. 5, the operation of the automated vehicle 10 is described in a mode where the vehicle switches to automated driving mode, the driver sets the destination, and the vehicle executes automatic longitudinal or lateral control such as lane maintenance, vehicle speed maintenance, or vehicle distance maintenance, including navigation control to the destination.

Additionally, the mode may switch from automated driving mode to manual driving mode through driver intervention in one of two ways: the driver commands the switch using the HVI, or the vehicle receives an indirect switching command to manual mode through driver actions such as steering or braking.

Referring to FIG. 5, the user may set the destination using a map module 180 (S40), and set the current location of the vehicle 10 and its route to the destination using a global navigation (S42). The set route may be transmitted to the DCU 160 (S44), which receives the route information (S46) and transmits control signals for automated driving on the received route (S48).

If the current location of the vehicle 10 is within the ODD but the destination is outside the ODD, the DCU 160 may request the vehicle 10 to operate in automated driving mode up to the ODD boundary and switch to manual driving mode thereafter.

In a mode where the driver directly intervenes and regains control of the vehicle in manual driving mode when automated driving mode is terminated or expected to be terminated, the vehicle may operate based on the driver's override.

The DCU 160 may receive the route (S46) and transmit the driving control signal for driving on the corresponding route to the automated driving controller 110 (S48).

The automated driving controller 110 may receive a first-level control signal among the driving control signals as described above (S50). This first-level signal may represent a relatively high level of control, including signals for controlling the second controller for automated driving.

Additionally, a relatively low second-level control signal among the driving control signals may be transmitted to the actuator 120 (S52), which receives the second-level signal (S54) and performs actuator control for steering and acceleration or deceleration (S56).

Accordingly, the automated driving mode may be executed (S58). Next, the description details the operation of the automated vehicle 10 when switching to manual driving mode while in automated driving mode.

While in automated driving mode, the user may set the change to manual driving mode using the HVI module 130. For example, the user may directly switch to manual driving mode through the input interface (S64). Alternatively, the actuator 120 may receive a control signal for acceleration or deceleration through direct driver control (S60).

Therefore, the automated driving controller 110 may receive the control signal from the actuator 120 and detect driver override (S62), or transmit the change to manual driving mode to the DCU 160 upon receiving the change to the manual driving mode through the HVI (S66).

The DCU 160 may generate a request for the driver to intervene (RTI) in automated driving (S68).

As the RTI is generated, the HVI module 130 may display an RTI response interface, requesting the fallback ready user (FRU) to take over the driving control (S70).

In response, the user may directly input the intention to manually drive the vehicle through the interface or use the actuator 120 for deceleration or acceleration control.

Upon detecting the driver override (S72), the vehicle 10 may complete the switch to manual driving mode (S74) and transmit the mode switching completion to the HVI module 130, allowing the HVI to display the driving mode as manual driving mode (S76).

Each module may then operate in manual driving mode (S78).

Thus, after the driver's control or change to manual driving mode is initially set, the vehicle 10 may explicitly request the RTI and finally complete the switch to manual driving mode upon receiving the response, enabling more reliable changes in driving mode during automated driving.

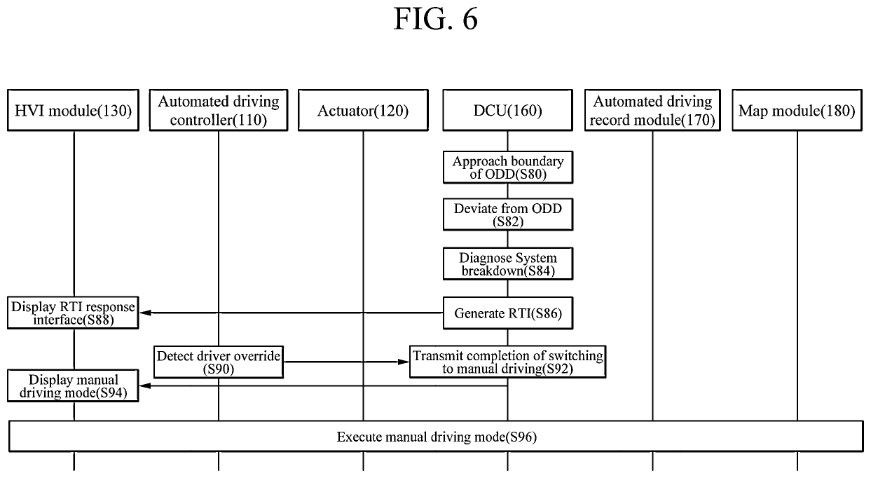

Next, the description outlines a more active fallback operation of the automated vehicle 10 for failure situations with reference to FIG. 6.

Referring to FIG. 6, the operation of the vehicle 10 is described when the MRM is executed by recognizing a predefined failure situation in automated driving.

In detail, the automated driving mode may be switched to manual driving mode by the system in one of the following three cases: For example, the automated vehicle 10 may continue its current driving route based on the ODD and is expected to approach the boundary of the ODD and eventually deviate from it, or the automated vehicle 10 may have already deviated from the ODD. In this case, the vehicle may generate an RTI and display the interface for requesting the driver to intervene in driving through the HVI module 130, thus requesting the driver to regain control.

Alternatively, the vehicle 10 may perform the MRM process when it is diagnosed as being unable to continue its current automated driving due to an error, breakdown, or similar issue in all or part of the automated driving system and its major components.

First, in relation to the ODD, the DCU 160 may receive the current driving mode of the vehicle 10 and predict in advance that the vehicle 10 is expected to approach the boundary of the ODD on the route and then deviate from the ODD (S80). The DCU 160 may determine a deviation time point and a deviation point by comparing the current speed and route of the vehicle 10 with the ODD in linkage with the map module 180.

Therefore, in this case, the DCU 160 may request the user to intervene in the driving in advance and generate an RTI to request a user response (S86).

Alternatively, when the vehicle has already deviated from the ODD (S82), the DCU 160 may generate the RTI (S86) and display the RTI response interface using the HVI module 130 (S88). Upon detecting the driver override through the interface (S90), the DCU 160 may complete the switch to manual driving and transmit this to the HVI module 130 (S92), allowing the HVI module 130 to display that the driving mode is switched to manual driving mode (S94).

Further, each device of the vehicle 10 may execute its operation based on the manual driving mode (S96).

Additionally, as described above, the vehicle may perform the operations through the same process even when an error or breakdown occurs in the automated driving system other than deviation from the ODD, causing a failure situation in automated driving (S84).

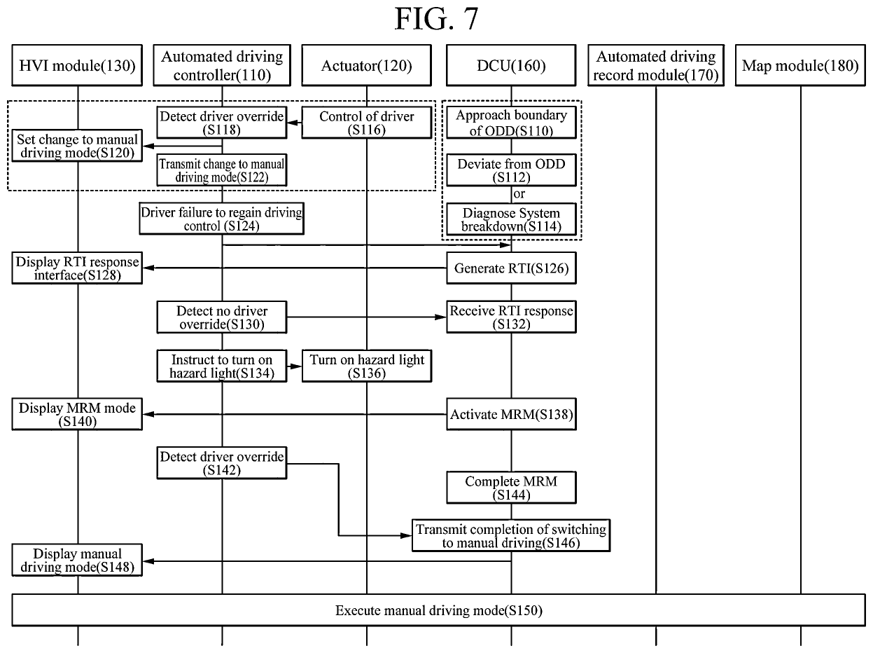

Next, referring to FIG. 7, the description outlines a situation where the MRM is activated because the driver does not respond to the RTI or the driver override is not detected, even though a failure situation occurs.

FIG. 7 shows the operation of the automated vehicle 10 when the MRM is activated because the driver does not respond to the RTI while the driving mode is switched from automated driving mode to manual driving mode by the system in one of the following cases.

Additionally, FIG. 7 subsequently shows a case where the driver successfully regains control even after the MRM is activated.

FIG. 7 shows that the RTI may be generated, and the MRM process may be activated based on the RTI even when the driver sets the switch to manual mode using the HVI module 130 (S120), but fails to take over control (S124), or even when the driver performs steering or braking actions using the actuator 120 (S116) and initial driver override is detected (S118), but the driver then fails to take over control (S124).

The MRM may also be activated when the automated vehicle 10 continues on its current driving route and is expected to deviate from the operational design domain (ODD (S110), or when the vehicle has already deviated from the ODD (S112) and the driver fails to take over the driving control (S124).

Additionally, the MRM may be activated when the vehicle is unable to continue automated driving due to an error or breakdown in all or part of the automated driving system and its major components (S114), and the driver fails to take over the driving control (S124).

Therefore, the DCU 160 may preferentially generate the RTI (S126). The DCU 160 may generate the RTI and display the RTI response interface using the HVI module 130 (S128).

If no user override is detected (S130), the DCU 160 may receive the response (S132). To initiate the MRM, the automated driving controller 110 may first instruct the hazard lights to turn on to inform the surrounding environment that a failure situation has occurred in the vehicle 10 and there is no driver intervention (S134).

The actuator 120 may turn on the hazard lights to alert the surrounding vehicles 10 of the situation (S136).

Next, the DCU 160 may activate the MRM (S138) and display an MRM mode interface using the HVI module 130 to indicate the activation of the MRM, even if the driver fails to intervene (S140). In level 4 or higher situations where the driver is not essential, the DCU 160 may inform passengers or users that the MRM operation is being performed.

When the MRM is activated, the MRM module in the automated driving controller 110 may monitor the mode of the automated driving system 100 and determine the MRM type based on the internal or external environment, as described above. The MRM type may be classified based on the stop situation and may include straight stop, in-lane stop, adjacent lane stop, and shoulder stop.

When the MRM is executed and the vehicle 10 stops based on the determined MRM type, the vehicle 10 may complete the MRM in a mode where the risk is minimized to the MRC (S144).

If the vehicle has difficulty stopping based on the type, the MRM may request an additional safe zone.

Furthermore, in this embodiment, the MRM may request a safe zone based on the predicted deviation point and deviation time when the activated MRM anticipates that the vehicle 10 will approach and then deviate from the ODD.

The map module 180 may be used when a safe zone, identified through an external server or roadside unit (RSU), is available. For example, the MRM may request in advance a specific location on the shoulder or in a parking zone for the vehicle to stop, set the driving route to reach the corresponding zone, and specifically request the driver to intervene based on the driving route.

Alternatively, the MRM may enable fallback by requesting the driver to intervene in the driving of the vehicle 10 at the predicted deviation time or in advance of this time.

In detail, the MRM may enable fallback before the deviation time by considering the speed and braking distance of the vehicle 10, road traffic congestion, or other factors at the deviation time.

For example, the MRM may enable the automated vehicle to stop at a safe stop zone by sequentially searching for a full-shoulder stop zone as the safe zone for some sections from the expected deviation time point, and if no safe zone is found in the above section, then searching for a half-shoulder stop zone.

Therefore, the MRM may allow fallback for the MRM situation in advance and adapt to external environmental variables based on changes in various road situations.

A vehicle performing the MRM may be controlled horizontally and vertically (using map data in some cases), and to minimize its impact on traffic flow, the vehicle 10 may request the nearest shoulder location to the ODD deviation prediction point as the safe zone.

If a full-shoulder stop is available as the safe zone based on the request, the vehicle may stop by receiving this information from the control server.

In this embodiment, the DCU 160 may predict the deviation point from the ODD on the route and request the safe zone in advance, allowing a vehicle capable of lateral and vertical control among broken vehicles to stop in the shoulder zone, thereby minimizing its impact on traffic flow and reducing accident situations caused by the broken vehicle.

In the case of a shoulder stop, it is possible to more smoothly evacuate passengers from the automated vehicle. Therefore, it is possible to prioritize a passenger's in the automated vehicle emergency stop request or an external request for a remote stop of the automated vehicle. Additionally, the DCU 160 may request the fallback ready user to intervene in driving during the MRM operation. When detecting the user override (S142), the control may be handed over to the driver, and the system may transmit completion of the switch to manual driving (S146), allowing the HVI module 130 to display the manual driving mode (S148). Each component may then execute the manual driving mode (S150).

In addition, when the automated vehicle 10 includes not only the driver but also multiple passengers, a passenger may recognize an external situation in advance or determine an internal breakdown situation and request an emergency stop.

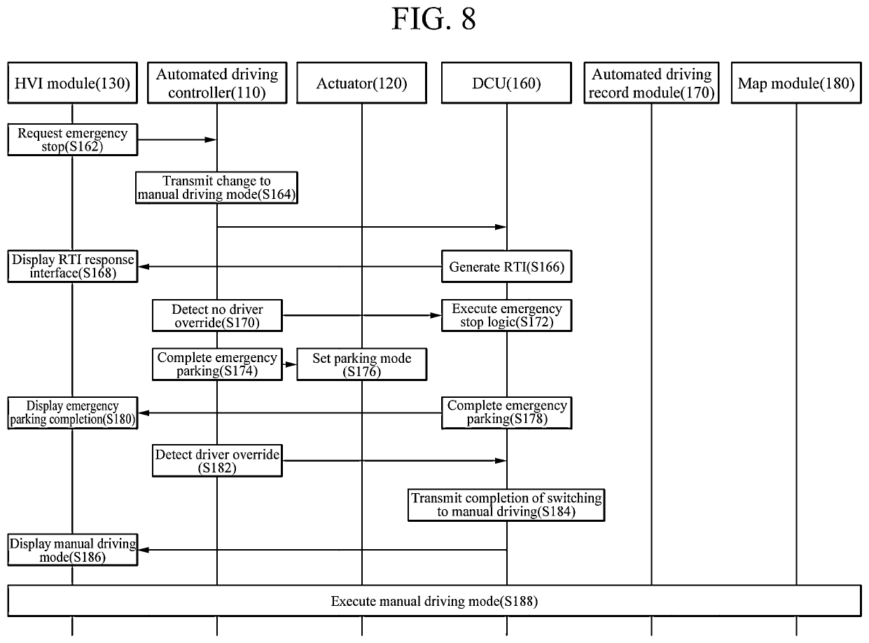

This case is described with reference to FIG. 8.

The case shown in FIG. 8 includes scenarios where the driver or a passenger presses an emergency stop button mounted in a shuttle bus or a large bus in automated driving mode to cause the bus to stop.

In detail, the case shown in FIG. 8 can be classified into a situation where the vehicle performs an emergency stop based on the MRM when the driver does not regain the control through driving manipulation, or when the driver regains the driving control by performing steering or braking actions.

Referring to FIG. 8, the driver or a passenger may request an emergency stop by pressing the emergency stop button included in the interface, such as the HVI module 130 (S162).

Upon receiving the emergency stop request, the automated driving controller 110 may transmit the switch to manual driving mode to the DCU 160 (S164).

The DCU 160 may receive the switch to manual driving mode, generate the RTI (S166), and request driver intervention using the HVI module 130 (S168). If no override is detected because the driver does not respond despite the passenger's emergency stop request (S170), the DCU 160 may execute emergency stop logic (S172), and the automated driving controller 110 may complete emergency parking (S174) and set the parking mode using the actuator 120 (S176).

Additionally, the DCU 160 may allow the HVI module 130 to display the emergency parking completion for the passenger or driver to recognize and feel reassured (S178, S180).

If driver override is detected (S182), the automated driving controller 110 may transmit this information again to the DCU 160, and the DCU 160 may complete the switch to manual driving (S184).

Once the switch to manual driving is complete, the DCU 160 may allow the HVI module 130 to display that the driving mode has switched to manual (S186) and execute the manual driving mode (S188).

In addition, the emergency stop may be performed not only by an internal request but also by an external road control system or infrastructure 20 linked to the RSU.

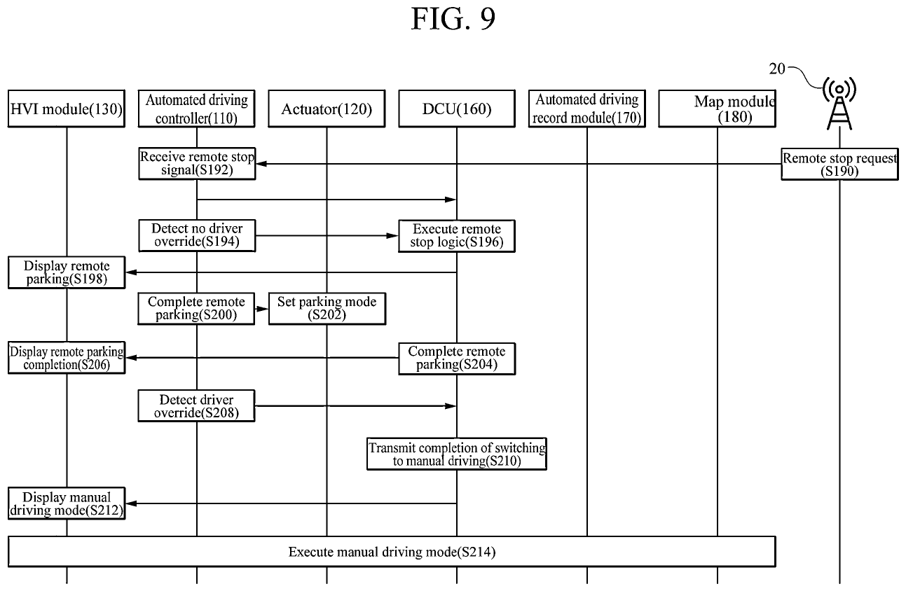

FIG. 9 shows the operation of the automated vehicle 10 when it receives a remote stop request as an instruction from the control system while in automated driving mode, and the driver does not regain control through driving manipulation, or the driver regains control by manipulating the steering or the brake.

Referring to FIG. 9, when the remote stop request is made from an external device (S190), the automated driving controller 110 may receive a remote stop signal (S192).

The received remote stop signal may be transmitted to the DCU 160, and if no driver override is detected in response to the RTI (S194), the DCU 160 may execute remote stop logic (S196).

When the remote stop logic is executed, the HVI module 130 may display a remote parking message for the user to recognize (S198). The automated driving controller 110 may complete the remote parking (S200) and then set the parking mode using the actuator 120 (S202). Once remote parking is complete (S204), the DCU 160 may display the remote parking completion using the HVI module 130 (S206).

If driver override e is detected (S208), the automated driving controller 110 may transmit this information again to the DCU 160, and the DCU 160 may complete the switch to manual driving (S210).

Once the switch to manual driving is complete, the DCU 160 may allow the HVI module 130 to display that the driving mode has switched to manual (S212) and execute the manual driving mode (S214).

Furthermore, when receiving the remote stop request as an instruction from an external control center and executing the remote stop logic because no driver override is detected, the vehicle 10 may receive information on the stop location based on the MRM type.

Therefore, before the vehicle 10 requests a safe zone, the control center may provide information on the safe zone along with the remote stop instruction. The provided safe zone information may be used for the vehicle to stop at the corresponding location using the map module 180.

Additionally, an automated driving record module 170 may generate driving records in conjunction with the map module 180 based on signals from the DCU 160 and the automated driving controller 110 related to the above operations and geographical information on the corresponding location, providing the vehicle with information on dangerous situations in various road infrastructures and additional information on surrounding vehicles based on the generated driving records.

The automated driving record module 170 may store information for 30 seconds or more before and after the occurrence/provision time when an accident occurs or fallback is provided while the automated vehicle drives, enabling analysis of the cause of the accident or breakdown.

As set forth above, according to the present invention, it is possible to increase the stability of the automated driving system when an emergency situation occurs.

Additionally, the present invention may provide the best fallback method by proposing a stable mode-switching method for the automated driving system.

Furthermore, the present invention may enable safer fallback by implementing a request for the driver to intervene in the MRM operation or the safe zone search in advance.

The various embodiments described herein may be implemented in a computer-readable recording medium or a similar device using, for example, software, hardware, or a combination thereof.

According to hardware implementation, the embodiments described herein may be implemented using at least one of application-specific integrated circuits (ASICs), digital signal processors (DSPs), digital signal processing devices (DSPDs), programmable logic devices (PLDs), field-programmable gate arrays (FPGAs), processors, controllers, microcontrollers, microprocessors, or electrical units for performing other functions. In some cases, the embodiments described in the specification may be implemented by a control module itself.

According to software implementation, the embodiments such as the procedures and functions described in the specification may be implemented by separate software modules. Each software module may perform one or more functions and operations described in the specification. Software code may be implemented as a software application written in a suitable programming language. The software code may be stored in a memory module and executed by the control module.

The spirit of the present invention has been illustratively described hereinabove. It is to be appreciated by those skilled in the art to which the present invention pertains that various modifications, alterations, and substitutions may be made without departing from the essential features of the present invention.

Accordingly, the embodiments and the accompanying drawings disclosed in the present invention are provided not to limit the spirit of the present invention but to describe the present invention, and the scope of the present invention is not limited to the embodiments or the accompanying drawings. The scope of the present invention should be interpreted by the following claims, and all equivalents to the claims should be interpreted to fall within the scope of the present invention.

1. A method for providing a fallback for a failure situation occurring in autonomous driving performed by an autonomous driving system, the method comprising:
predicting whether a vehicle deviates from an operational design domain (ODD) where the vehicle performs the autonomous driving on a route while the vehicle drives; and
performing a minimal risk maneuver (MRM) process of controlling the vehicle to provide the fallback for the failure situation occurring in the autonomous driving based on a deviation point when the deviation is predicted.

2. The method of claim 1, wherein the MRM process includes
making a request for a vehicle driver to intervene in the autonomous driving at a time point when the deviation is predicted or in advance from the time point, and
changing a driving mode to a manual driving mode when a vehicle control is given over to the driver by the driver intervention (or override).

3. The method of claim 2, wherein the MRM process includes instructing an emergency stop of the vehicle when the driver intervention is impossible.

4. The method of claim 3, wherein the MRM process is classified into necessary control operations based on a MRM type that determines a stop type by a diagnosis result of a failure cause of the vehicle.

5. The method of claim 4, wherein the MRM process requests safe zone information required based on the MRM type, and generates a route for the vehicle to stop on a received safe zone.

6. The method of claim 5, further comprising receiving a remote request to perform the MRM process from a control server when the deviation from the ODD or occurrence of the failure situation is determined as a monitoring result while the vehicle drives,
wherein the control server provides the safe zone information when making the request to perform the MRM process.
